(19) United States
(12) Patent Application Publication
(10) Pub. No.: US 2023/0056731 A1
(43) Pub. Date: Feb. 23, 2023

(54) MODULAR CARGO STORAGE SYSTEM FOR PASSENGER VEHICLE

(71) Applicant: Indiev, Inc, Los Angeles, CA (US)

(72) Inventors: Andre Hudson, Los Angeles, CA (US); Young Joon Ju, Los Angeles, CA (US)

(21) Appl. No.: 17/409,089

(22) Filed: Aug. 23, 2021

(51) Int. Cl. B60R 7/02

(52) U.S. Cl. CPC B60R 7/02

(57) ABSTRACT

Provided are modular cargo storage systems for passenger vehicles, as well as methods of using the same. A modular cargo system can include a plurality of rails each having a plurality of slots at a lower portion thereof, as well as a plurality of click and lock modules, which are a type of removable fastener that can be squeezed to fit inside one of the rails and released to be removably secured within a slot position of the rail. The click and lock modules can be placed as desired within the rails, and within the slots of the respective rails as desired, and stretchable bands can be connected to the click and lock modules as desired in order to customize the storage capability of the modular cargo storage system.

### BACKGROUND

Passenger vehicles are often used to store and transport cargo of the owner and/or passengers. Consumers are constantly on the lookout for increased cargo space and flexibility in the passenger vehicle marketplace. Such vehicles typically have a trunk or hatchback area near the rear of the vehicle behind the rear row of seats.

### BRIEF SUMMARY

Embodiments of the subject invention provide novel and advantageous modular cargo storage systems for passenger vehicles, as well as methods of using and fabricating the same. A modular cargo system can include a plurality of rails each having a plurality of slots at a lower portion thereof, as well as a cargo load mat with holes formed therein respectively corresponding to rails of the plurality of rails. The rails can be exposed through the holes of the cargo load mat and can either be disposed respectively within the holes of the cargo load mat or disposed below the cargo load mat while being exposed respectively through the holes. The system can include a plurality of click and lock modules (“CL modules”), which are a type of removable fastener that can be squeezed to fit inside one of the rails and released to be removably secured within a slot position of the rail. The CL modules can be squeezed again and pulled out to remove from the slot position (e.g., to move to a different slot within the same rail or in a different rail of the system). The system can also include at least one band (e.g., an elastic band) that can be (removably or permanently) affixed to two CL modules in order to provide a connected strap configuration to hold cargo in place inside the passenger vehicle. The CL modules can be placed as desired within the rails, and within the slot positions of the respective rails as desired (CL modules can also be removed from the system entirely), and the band(s) can be connected to CL modules as desired (bands can also be removed from the system entirely) in order to customize the storage capability of the modular cargo storage system. Additional CL modules and/or bands can be added to the system as needed/desired. The system is completely customizable at any time by easily moving CL modules and/or bands to a desired configuration.

In an embodiment, a modular cargo system for a passenger vehicle can comprise: a plurality of rails, each rail of the plurality of rails comprising a plurality of slot positions, wherein each slot position comprises two slots opposite to each other across an opening of the rail; and a plurality of CL modules, each CL module being configured to be removably inserted into and disposed in a slot position of the plurality of slot positions in a rail of the plurality of rails. Each CL module can comprise: a first upper flange and a second upper flange opposite from each other and configured to be squeezed towards each other by a user of the system; a first lower inner wall connected to the first upper flange; a second lower inner wall opposite from the first lower inner wall and connected to the second upper flange; a first lower lateral extending portion connected to the first lower inner wall and extending laterally away from a lower portion of the CL module; and a second lower lateral extending portion extending laterally away from the lower portion of the CL module, the second lower lateral extending portion being opposite from the first lower lateral extending portion and being connected to the second lower inner wall. The first lower lateral extending portion and the second lower lateral extending portion can be configured such that, when the first upper flange and the second upper flange are squeezed towards each other, the first lower lateral extending portion and the second lower lateral extending portion correspondingly move towards each other.

Each CL module can comprise a spring disposed between the first lower inner wall and the second lower inner wall; each CL module can be configured such that when the first upper flange and the second upper flange are squeezed towards each other, the first inner wall and the second inner wall correspondingly move towards each other and cause the spring to compress; and each CL module can be configured such that when the spring is compressed and no external pressure is applied to the first upper flange and the second upper flange, the spring extends and causes the first inner wall and the second inner wall to move away from each other, thereby causing the first upper flange and the second upper flange to correspondingly move away from each other. A greatest distance, measured in a lateral direction of the CL module, from an outer lateral surface of the first lower lateral extending portion to an outer lateral surface of the second lower lateral extending portion when the spring is fully extended can be greater than a first width of the opening of each rail of the plurality of rails. A second distance, measured in the lateral direction, from the outer lateral surface of the first lower lateral extending portion to an outer lateral surface of the second lower lateral extending portion when the spring is fully compressed can be less than the first width. Within each slot position, a second width between the two slots opposite to each other can be greater than both the second distance and the first width. The first lower lateral extending portion can extend laterally away from the lower portion of the CL module in a first direction parallel to a central vertical axis of the CL module, and the second lower lateral extending portion can extend laterally away from the lower portion of the CL module in a second direction opposite from the first direction. Each CL module can comprise a handle at an upper portion thereof, and the handle can be configured to be rotated while the respective CL module is disposed in the slot position (e.g., to be rotated independent of the remainder of the CL module). Each CL module can comprise a main body on which the handle is disposed, and the main body can comprise a first indented space and a second indented space at positions corresponding to where the first upper flange and the second upper flange, respectively, are disposed, such that the first upper flange and the second upper flange are squeezed towards each other into the first indented space and the second indented space, respectively. A portion of the first upper flange connecting to the first lower inner wall, a portion of the second upper flange connecting to the second lower inner wall, the first lower inner wall, and/or the second lower inner wall can be contained within a lateral wall of the main body. The first lower lateral extending portion can extend out from the first lower wall through a first hole in the lateral wall of the main body, and/or the second lower lateral extending portion can extend out from the second lower wall through a second hole in the lateral wall of the main body. The first upper flange, the first lower inner wall, and the first lower lateral extending portion can be monolithically formed with each other, and/or the second upper flange, the second lower inner wall, and the second lower lateral extending portion can be monolithically formed with each other.

The system can further comprise at least one cargo load mat, each comprising holes. The rails of the plurality of rails can be: respectively disposed within the holes of the at least one load cargo mat; or disposed below the at least one cargo load mat and respectively exposed through the holes of the at least one cargo load mat. The at least one cargo load mat can comprise at least one of: a first cargo load mat disposed on a floor of a cargo area of the passenger vehicle; a second cargo load mat disposed on a back of a rear seat of the passenger vehicle; a third cargo load mat disposed on a first side wall of the cargo area of the passenger vehicle; and a fourth cargo load mat disposed on a second side wall of the cargo area of the passenger vehicle. The system can further comprise at least one stretchable band configured to be removably fastened to CL modules of the plurality of CL modules.

In another embodiment, a passenger vehicle comprises a modular cargo system as described herein. The passenger vehicle can be, for example, an electric vehicle. The modular cargo system can be in a cargo area of the passenger vehicle (e.g., in a rear portion behind a rear seat and/or in a front portion under a hood in front of a dashboard/instrument panel).

### BRIEF DESCRIPTION OF DRAWINGS

FIG. 1 shows a plan view of part of a modular cargo storage system, according to an embodiment of the subject invention. The inset is an enlarged view of the left-most rail depicted in the main portion of the figure.

FIG. 2A shows a plan view of part of a modular cargo storage system, according to an embodiment of the subject invention.

FIG. 2B shows a top view of two rails and two click and lock modules (“CL modules”) of a modular cargo storage system, according to an embodiment of the subject invention.

FIG. 3A shows a plan view of part of a modular cargo storage system, according to an embodiment of the subject invention.

FIG. 3B shows a top view of two rails and two CL modules of a modular cargo storage system, according to an embodiment of the subject invention.

FIG. 4A shows a cross-sectional view of a CL module and a rail (in the top portion of the figure), and a top view of the CL module (in the bottom portion of the figure, linked by the dotted lines), according to an embodiment of the subject invention.

FIG. 4B shows a cross-sectional view of a CL module being inserted into a rail (in the top portion of the figure), and a top view of the CL module (in the bottom portion of the figure, linked by the dotted lines), according to an embodiment of the subject invention.

FIG. 4C shows a cross-sectional view of a CL module inserted into a rail (in the top portion of the figure), and a top view of the CL module (in the bottom portion of the figure, linked by the dotted lines), according to an embodiment of the subject invention.

FIG. 4D shows a cross-sectional view of a CL module inserted into a rail and having its handle rotated (in the top portion of the figure), and a top view of the CL module (in the bottom portion of the figure, linked by the dotted lines), according to an embodiment of the subject invention.

FIG. 5 shows a plan view of part of a modular cargo storage system, according to an embodiment of the subject invention.

FIG. 6 shows a top view of two rails and two CL modules (with a band connected thereto) of a modular cargo storage system, according to an embodiment of the subject invention.

FIG. 7 shows a plan view of part of a modular cargo storage system containing some cargo items (depicted in dotted lines), according to an embodiment of the subject invention.

FIG. 8A shows a modular cargo storage system in a passenger vehicle, according to an embodiment of the subject invention.

FIG. 8B shows a modular cargo storage system in a passenger vehicle, according to an embodiment of the subject invention.

### DETAILED DESCRIPTION

Embodiments of the subject invention provide novel and advantageous modular cargo storage systems for passenger vehicles, as well as methods of using and fabricating the same. A modular cargo system can include a plurality of rails each having a plurality of slots at a lower portion thereof, as well as a cargo load mat with holes formed therein respectively corresponding to rails of the plurality of rails. The rails can be exposed through the holes of the cargo load mat and can either be disposed respectively within the holes of the cargo load mat or disposed below the cargo load mat while being exposed respectively through the holes. The system can include a plurality of click and lock modules (“CL modules”), which are a type of removable fastener that can be squeezed to fit inside one of the rails and released to be removably secured within a slot position of the rail. The CL modules can be squeezed again and pulled out to remove from the slot position (e.g., to move to a different slot within the same rail or in a different rail of the system). The system can also include at least one band (e.g., an elastic band) that can be (removably or permanently) affixed to two CL modules in order to provide a connected strap configuration to hold cargo in place inside the passenger vehicle. The CL modules can be placed as desired within the rails, and within the slot positions of the respective rails as desired (CL modules can also be removed from the system entirely), and the band(s) can be connected to CL modules as desired (bands can also be removed from the system entirely) in order to customize the storage capability of the modular cargo storage system. Additional CL modules and/or bands can be added to the system as needed/desired. The system is completely customizable at any time by easily moving CL modules and/or bands to a desired configuration.

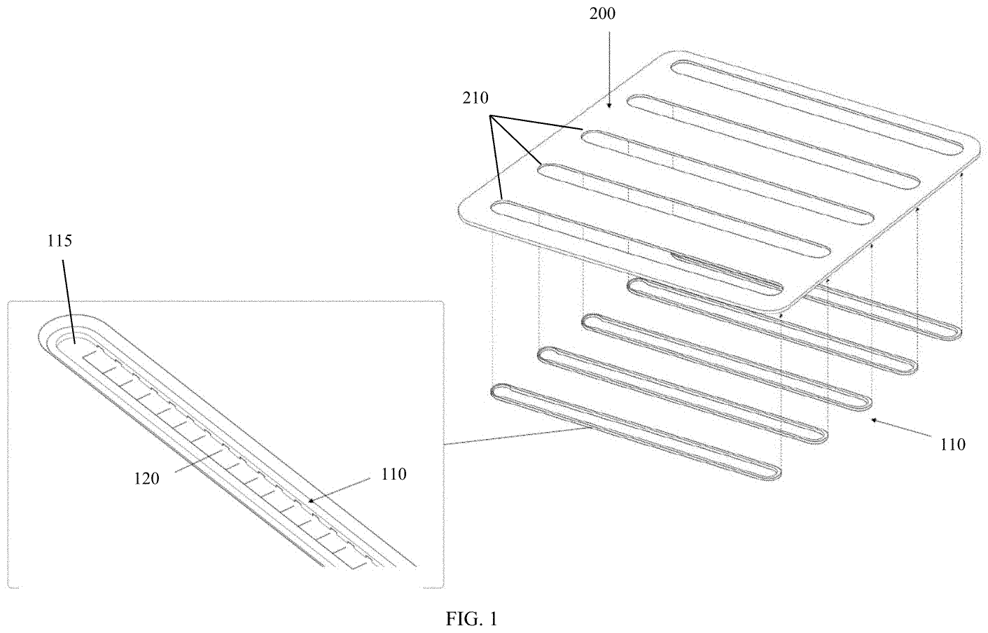

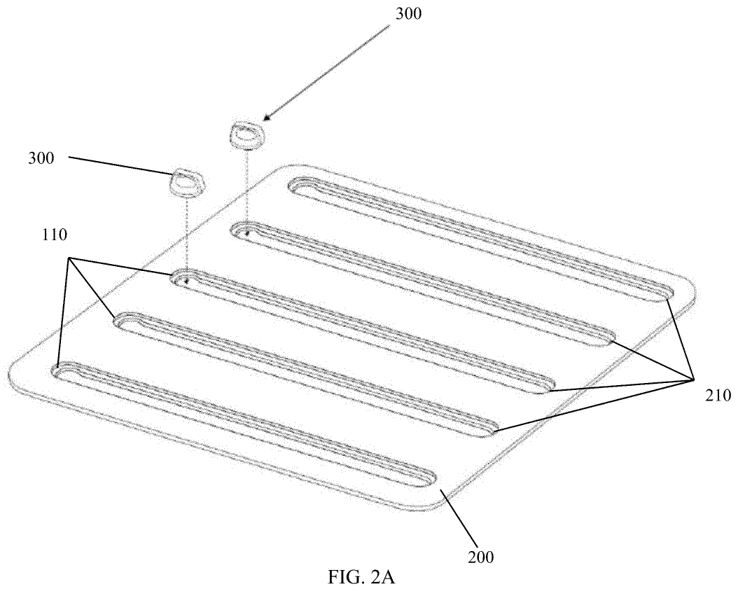

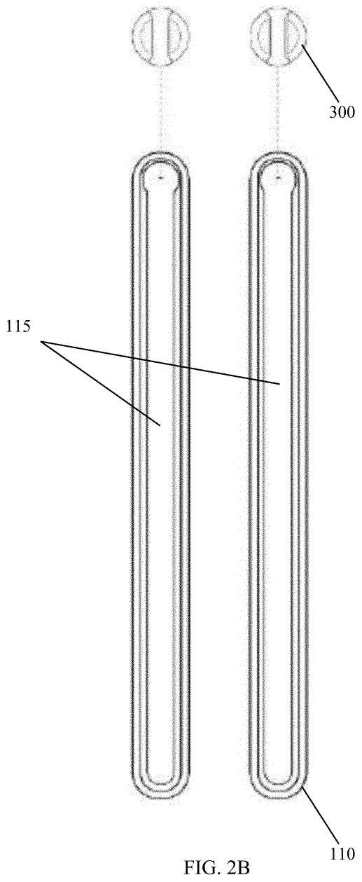

FIGS. 1 and 2A show plan views of part of a modular cargo storage system, according to embodiments of the subject invention. The modular cargo storage system can include a cargo load mat 200 that can include a plurality of holes 210. The system can further include a plurality of rails 110 each having a plurality of slots 120 at a lower portion thereof. The rails 110 can be exposed through the holes 210 of the cargo load mat 200 (see, e.g., FIG. 2A) and can either be disposed respectively within the holes 210 of the cargo load mat 200 or disposed below the cargo load mat 200 while being exposed respectively through the holes 210. A plurality of CL modules 300 can be provided and are configured to be removably inserted into the rails 110 of the system. FIG. 2B shows an enlarged top view of the two rails 110 of FIG. 2A that have the CL modules 300 shown with dotted lines.

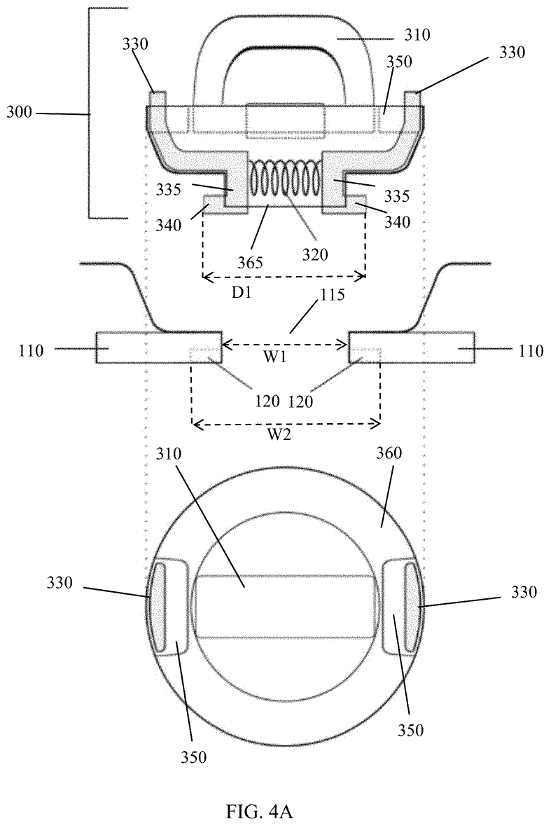

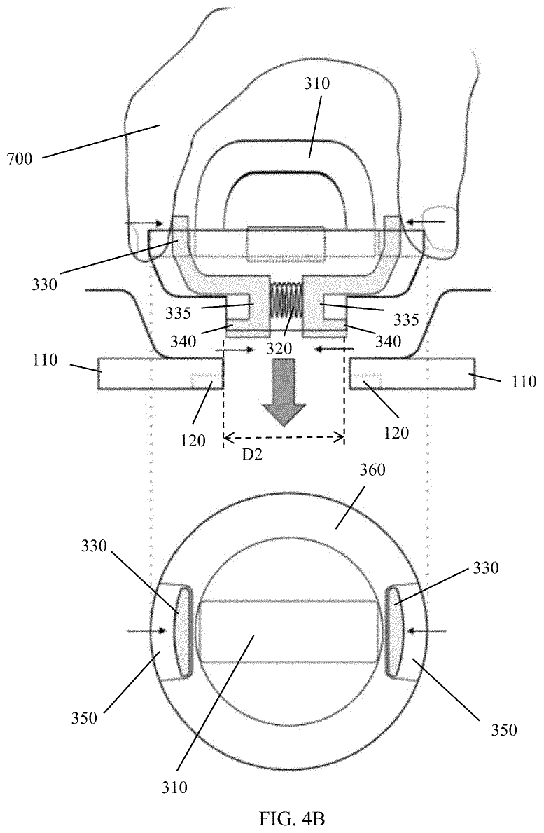

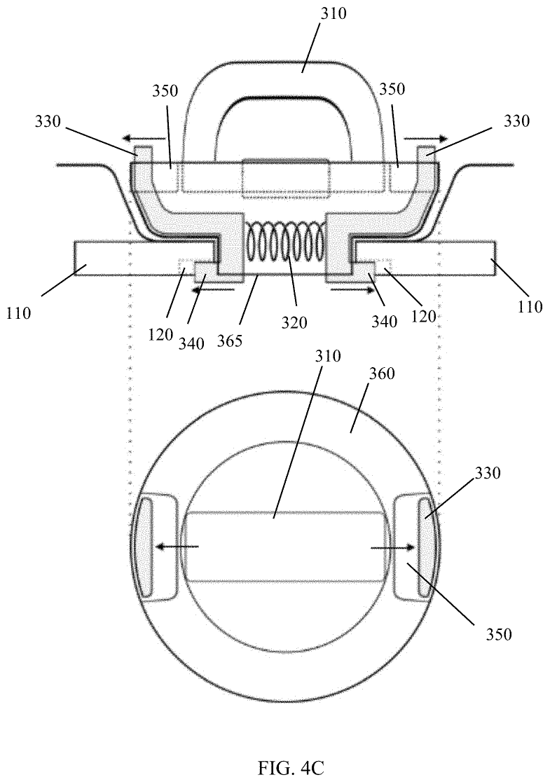

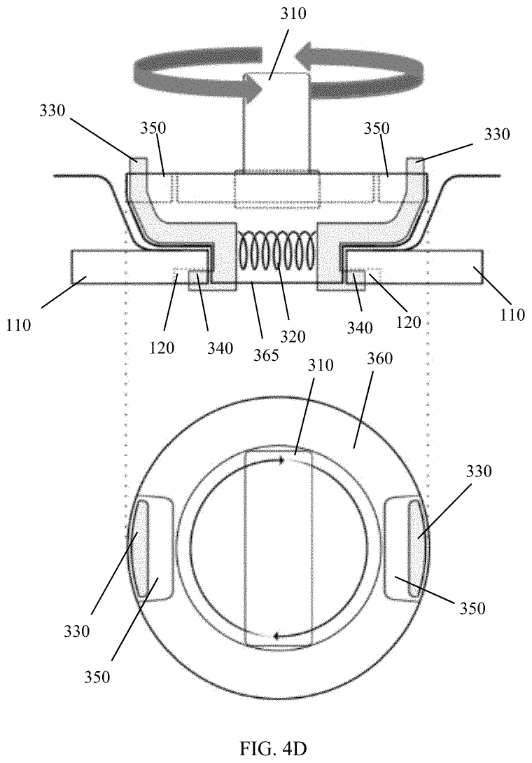

The inset of FIG. 1 shows an enlarged view of one of the rails 110 from the main portion of the figure. As seen in the inset of FIG. 1, slots 120 can be provided along the longitudinal length of the rail 110 (though embodiments are not limited thereto). The slots 120 can be provided on both sides of the opening 115 of the rail, such that they match up with each other. That is, two slots 120 can be provided on opposite sides of the opening 115 in the same position along the length of the rail 110 to make a slot position into which the lower lateral extending portions 340 of a CL module 300 can be inserted to keep the CL module in place within the rail 110 (see also FIGS. 4A-4D). In some embodiments, each slot 120 of a rail 110 can have a corresponding slot 120 provided on the opposite side of the opening 115 in the same position along the length of the rail 110 to make a slot position into which the lower lateral extending portions 340 of a CL module 300 can be inserted to keep the CL module in place within the rail 110. Any or all rails 110 can have slots 120 as described herein.

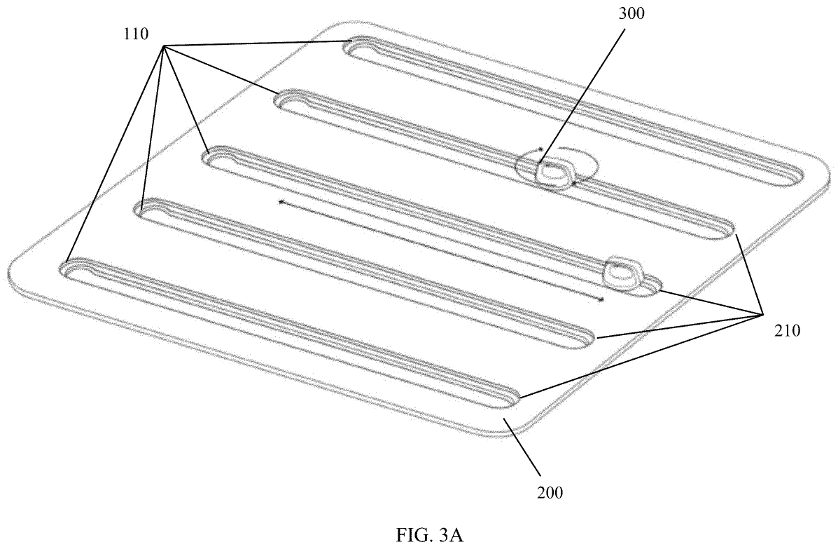

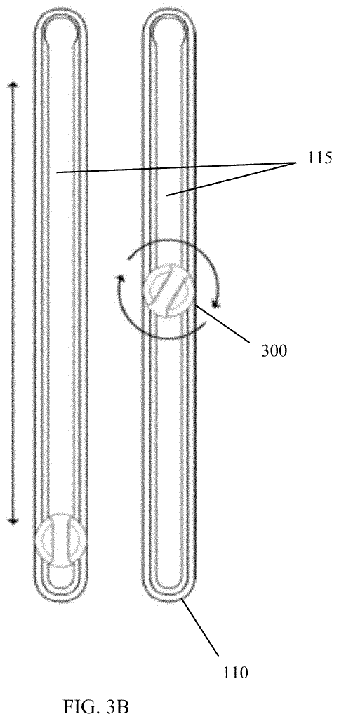

Referring to FIG. 3A, the CL modules 300 can be rotated (e.g., to enable a band 400 to be more conveniently attached to the handle 310 of the CL module 300, or in some cases to enable the CL module 300 to move within the rail 110). The CL module 300 can be slid within the same rail 110 by squeezing the upper flanges 330 (such that the lower lateral extending portions 340 are no longer in the slots 120) and then sliding the CL module 300. When the CL module 300 is in the desired position within the rail 110, the upper flanges 330 can be released such that the lower lateral extending portions 340 are inserted into the slots 120 in the new location. FIG. 3B shows an enlarged top view of the two rails 110 of FIG. 3A that have the CL modules 300 inserted therewithin. The long double arrow in FIGS. 3A and 3B represents how the CL module 300 can be disposed along the entire length of the opening 115 of the rail 110, and the circular arrows in FIGS. 3A and 3B represents how the handle 310 of the CL module 300 can be rotated to any desired position.

FIGS. 4A-4D show cross-sectional views of a CL module 300 and a rail 110 (in the top portion of each figure), and top views of the CL module 300 (in the bottom portion of each figure, linked by the dotted lines), demonstrating inserting a CL module 300 into a slot 200 of a rail 110. Referring to FIGS. 4A-4D, the CL module 300 can include a handle 310 at a top portion thereof, which can be used for, e.g., gripping/holding the CL module 300 by a user 700 and/or connecting a band 400. The CL module 300 can have upper flanges 330 that are connected to lower inner walls 335, which are adjacent to a spring 320. The lower inner walls 335 are connected to lower lateral extending portions 340 that extend laterally away from a lower portion of the CL module 300. The CL module 300 can include two upper flanges 330 opposite (e.g., diametrically opposite) from each other, two lower inner walls 335 opposite (e.g., diametrically opposite) from each other and on respective opposite ends of the spring 320, and two lower lateral extending portions 340 opposite (e.g., diametrically opposite) from each other and near respective opposite ends of the spring 320. Each respective upper flange 330 can be monolithically formed with the respective lower inner wall 335 and/or the respective lower inner wall 335 can be monolithically formed with the respective lower lateral extending portion 340 (e.g., the upper flange 330, the lower inner wall 335, and the lower lateral extending portion 340 can all be monolithically formed with each other on each respective side of the CL module 300).

The CL module 300 can further comprise a main body 360, which can in many embodiments have a circular or generally circular shape (e.g., the upper surface of the main body 360 can be circular or generally circular, as shown in the bottom portions of FIGS. 4A-4D). The main body 360 can have indented spaces 350 at portions where the upper flanges 330 are disposed. In this way, the CL module 300 is (and the upper flanges 330 of the CL module 300 are) configured such that the upper flanges 330 can be pressed towards each other (and towards a radial center of the CL module 300) causing the lower inner walls 335 to compress the spring 320 and causing the lower lateral extending portions 340 to move inward towards each other (and towards a radial center of the CL module 300). The main body 360 can optionally include a lower surface 365 such that the spring 320 is enclosed from below by the lower surface 365 of the main body 360. A portion of the upper flange 330 connecting to the lower inner wall 335 can optionally be contained within the lateral wall of the main body 360, as can the lower inner wall 335 itself. The lower lateral extending portion 340 can optionally extend out from the lower wall 335 through a hole in the lateral wall of the main body 360.

The opening 115 of the rail 110 can have a width W1 (from one side that has slots 120 to the other side that has slots 120) that is less than a distance D1 (measured in a lateral (or radial) direction (i.e., the direction in which the spring 320 extends and compresses) of the CL module 300) from an outer lateral surface of a first lower lateral extending portion 340 to an outer lateral surface of a second lower lateral extending portion 340 (opposite from the first lower lateral extending portion 340) when the spring 320 is not compressed (i.e., when the upper flanges 330 are not squeezed at all, this distance D1 being a greatest distance between the outer surfaces of the lower lateral extending portions 340). The distance D2 (measured in the lateral (or radial) direction (i.e., the direction in which the spring 320 extends and compresses) of the CL module 300) from the outer lateral surface of the first lower lateral extending portion 340 to the outer lateral surface of the second lower lateral extending portion 340 when the spring 320 is fully compressed (i.e., when the upper flanges 330 are squeezed, this distance D2 being a smallest distance between the outer surfaces of the lower lateral extending portions 340) is less than the width W1 of the opening 115 of the rail 110. In this way, the CL module 300 stays in the slots 120 of the rail 110 once it is inserted thereinto unless the upper flanges 330 are squeezed to remove the CL module 300 from the slots 120.

A greatest width W2 between two slots 120 opposite to each other across the opening 115 of the rail 120 is greater than both W1 and D2. The width W2 can be greater than, equal to, or less than D1. If W2 is less than D1, then when the CL module 300 is disposed in the slots 120 and the upper flanges 330 are not squeezed at all, the spring 320 will still have some compression.

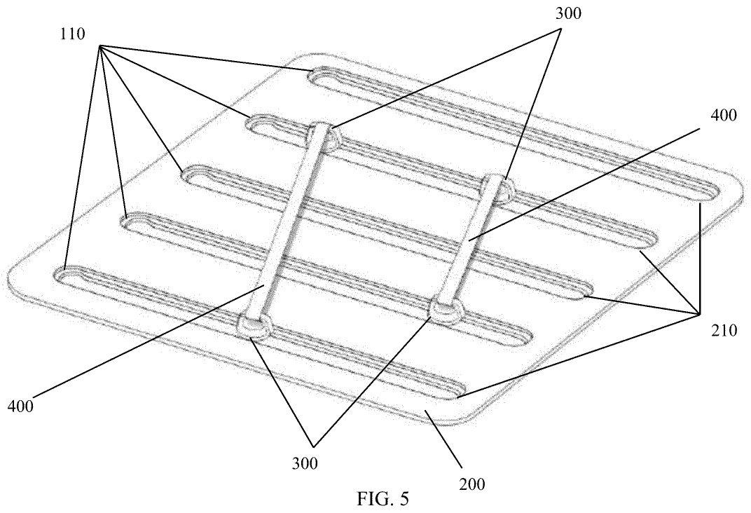

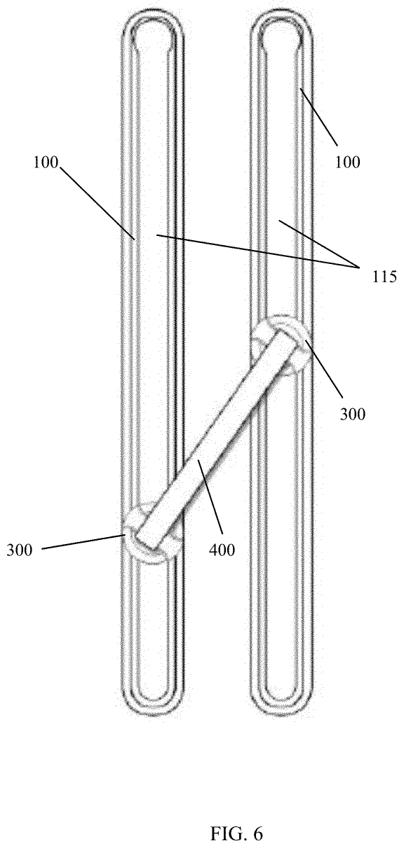

As shown in FIG. 4A, before squeezing the upper flanges 330, the spring 320 is extended, pushing the lower lateral extending portions 340 outward (via the lower inner walls 335) such that D1 is greater than W1. As shown in FIG. 4B, a user 700 can squeeze the upper flanges 330 into the indented spaces 350, causing the spring to compress (via the lower inner walls 335) and causing the lower lateral extending portions 340 to move towards each other. Once the distance D2 is less than W1, the CL module 300 can be lowered into the rail 110 at the desired opposing slots 120. As shown in FIG. 4C, the user 700 can release the upper flanges 330, allowing the spring 320 to push out the lower inner walls 335 and therefore cause the lower lateral extending portions 340 to move outward such that D1 is greater than W1 again, thereby locking the CL module 300 into the desired slot position (i.e., the desired opposing slots 120) via the lower lateral extending portions 340 being respectively inserted into the opposing slots 120. As shown in FIG. 4D, the handle 310 of the CL module 300 can be rotated (e.g., in a circumferential direction of the CL module 300). The handle 310 can rotate independently of other elements of the CL module 300, leaving the CL module 300 locked in the slot position while the handle 310 is rotated to a desired orientation for connection with a band 400 (see also, e.g., FIGS. 5 and 6).

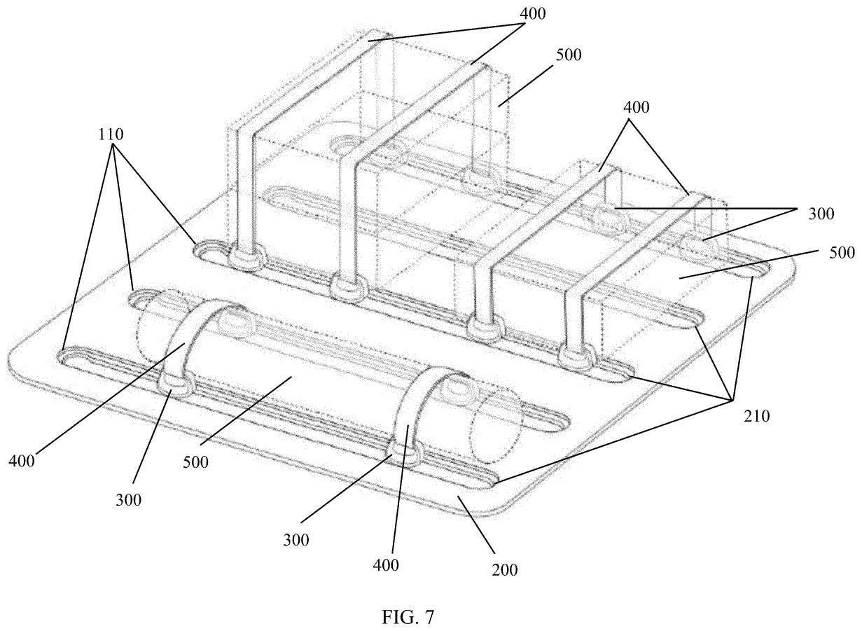

Referring to FIGS. 5 and 6, one or more bands 400 can be connected to CL modules 300 of the system, for example by removably fastening to the respective handles 310 of the CL modules 300. The bands 400 can be stretchable bands and can be made of any suitable material known in the art (e.g., can comprise an elastic material). This setup is similar to using bungee cords to connect to anchor points in the bed of a pickup truck, but in the modular cargo storage systems of embodiments of the subject invention, the CL modules 300 serving as the equivalent of the anchor points are completely movable to any point (having a slot position within a rail) within the cargo area. Also, the handles 310 of the CL modules 300 can be rotated to any orientation to provide further customizability to the modular cargo storage system. FIG. 7 shows an example of CL modules 300 and bands 400 being used to hold various pieces of cargo 500 in place on a cargo load mat 200. The arrangement shown in FIG. 7 is just one example and, as discussed in detail herein, any arrangement can be used by adding/removing/relocating CL modules 300 and/or bands 400 (and/or rotating the handles 310 of the CL modules 300).

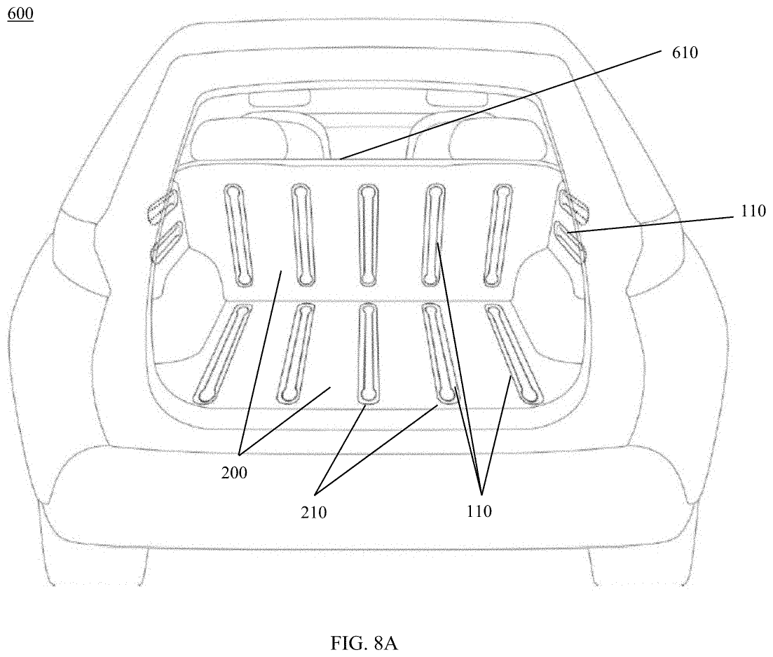

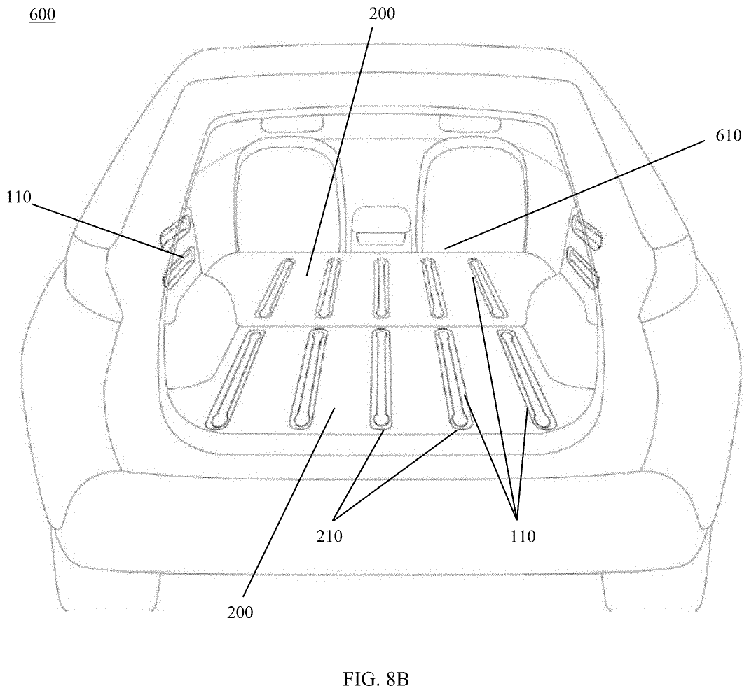

FIGS. 8A and 8B show rear views of a passenger vehicle 600 with the back hatch open and having a modular cargo storage system, according to an embodiment of the subject invention. The system includes a plurality of cargo load mats 200, including on the rear seat 610 and the sides of the cargo area. FIG. 8A shows the case where the rear seat 610 (e.g., to allow for more passenger space) is up, and FIG. 8B shows the case where the rear seat 610 is down (e.g., to allow for more cargo space). In either case, the cargo load mat 200 on the back of the rear seat 610 can be used for locating CL modules 300.

Embodiments of the subject invention provide modular cargo storage systems for passenger vehicles. By moving, rearranging, adding, and/or removing elements of the system (e.g., cargo load mats, rails, CL modules, and/or bands), countless arrangements for storing cargo can be generated, allowing for extreme versatility in cargo fastening/storage possibilities. The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

The subject invention includes, but is not limited to, the following exemplified embodiments.

Embodiment 1. A modular cargo system for a passenger vehicle, the modular cargo system comprising:

a plurality of rails, each rail of the plurality of rails comprising a plurality of slot positions, wherein each slot position comprises two slots opposite to each other across an opening of the rail; and

a plurality of click and lock modules (CL modules), each CL module being configured to be removably inserted into and disposed in a slot position of the plurality of slot positions in a rail of the plurality of rails.

Embodiment 2. The modular cargo system according to embodiment 1, further comprising at least one cargo load mat, each comprising holes.

Embodiment 3. The modular cargo system according to embodiment 2, wherein the rails of the plurality of rails are respectively disposed within the holes of the at least one load cargo mat.

Embodiment 4. The modular cargo system according to embodiment 2, wherein the rails of the plurality of rails are disposed below the at least one cargo load mat and are respectively exposed through the holes of the at least one cargo load mat.

Embodiment 5. The modular cargo system according to any of embodiments 2-4, wherein the at least one cargo load mat comprises a first cargo load mat disposed on a floor of a cargo area of the passenger vehicle.

Embodiment 6. The modular cargo system according to any of embodiments 2-5, wherein the at least one cargo load mat comprises a second cargo load mat disposed on a back of a rear seat of the passenger vehicle.

Embodiment 7. The modular cargo system according to any of embodiments 2-6, wherein the at least one cargo load mat comprises a third cargo load mat disposed on a first side wall of a cargo area of the passenger vehicle and/or a fourth cargo load mat disposed on a second side wall of the cargo area of the passenger vehicle.

Embodiment 8. The modular cargo system according to any of embodiments 1-7, further comprising at least one stretchable band configured to be removably fastened to CL modules of the plurality of CL modules.

Embodiment 9. The modular cargo system according to embodiment 8, wherein the at least one stretchable band comprises an elastic material.

Embodiment 10. The modular cargo system according to any of embodiments 1-9, wherein each CL module of the plurality of CL modules comprises a handle (configured to be gripped and/or held by a user of the system, and configured to have the at least one stretchable band (if present) be removably fastened thereto) at an upper portion thereof.

Embodiment 11. The modular cargo system according to embodiment 10, wherein the handle is configured to be rotated/rotatable while the respective CL module is disposed in the slot position.

Embodiment 12. The modular cargo system according to embodiment 11, wherein the handle is configured to be rotated/rotatable independent of a remainder of the CL module.

Embodiment 13. The modular cargo system according to any of embodiments 1-12, wherein each CL module of the plurality of CL modules comprises:

a first upper flange and a second upper flange opposite (e.g., diametrically opposite) from each other and configured to be squeezed towards each other by a user of the system;

a first lower inner wall connected to the first upper flange;

a second lower inner wall opposite (e.g., diametrically opposite) from the first lower inner wall and connected to the second upper flange;

a first lower lateral extending portion connected to the first lower inner wall and extending laterally away from a lower portion of the CL module; and

a second lower lateral extending portion extending laterally away from the lower portion of the CL module, the second lower lateral extending portion being opposite (e.g., diametrically opposite) from the first lower lateral extending portion and being connected to the second lower inner wall,

wherein the first lower lateral extending portion and the second lower lateral extending portion are configured such that, when the first upper flange and the second upper flange are squeezed towards each other, the first lower lateral extending portion and the second lower lateral extending portion correspondingly move towards each other.

Embodiment 14. The modular cargo system according to embodiment 13, wherein each CL module of the plurality of CL modules comprises a spring disposed between the first lower inner wall and the second lower inner wall,

wherein the CL module is configured such that when the first upper flange and the second upper flange are squeezed towards each other, the first inner wall and the second inner wall correspondingly move towards each other and cause the spring to compress, and

wherein the CL module is configured such that when the spring is compressed and no external pressure is applied to the first upper flange and the second upper flange, the spring extends and causes the first inner wall and the second inner wall to move away from each other, thereby causing the first upper flange and the second upper flange to correspondingly move away from each other.

Embodiment 15. The modular cargo system according to any of embodiments 13-14, wherein the first lower lateral extending portion extends laterally away from the lower portion of the CL module in a first direction parallel to a central vertical axis of the CL module, and wherein the second lower lateral extending portion extends laterally away from the lower portion of the CL module in a second direction opposite from the first direction.

Embodiment 16. The modular cargo system according to any of embodiments 13-15, wherein, within each CL module of the plurality of CL modules, a greatest distance (measured in a lateral (or radial) direction (i.e., the direction in which the spring extends and compresses) from an outer lateral surface of the first lower lateral extending portion to an outer lateral surface of the second lower lateral extending portion (i.e., when the spring is not compressed) is greater than a first width of the opening of each rail of the plurality of rails.

Embodiment 17. The modular cargo system according to any of embodiments 13-16, wherein, within each CL module of the plurality of CL modules, a second distance (measured in a lateral (or radial) direction (i.e., the direction in which the spring extends and compresses) from an outer lateral surface of the first lower lateral extending portion to an outer lateral surface of the second lower lateral extending portion (i.e., when the spring is (fully) compressed) is less than a first width of the opening of each rail of the plurality of rails.

Embodiment 18. The modular cargo system according to embodiment 17, wherein, within each slot position of the plurality of slot positions within each rail of the plurality of rails, a second width between the two slots opposite to each other is greater than both the second distance and the first width.

Embodiment 19. The modular cargo system according to embodiment 18, wherein the second width is greater than a greatest distance (measured in a lateral (or radial) direction (i.e., the direction in which the spring extends and compresses) from the outer lateral surface of the first lower lateral extending portion to the outer lateral surface of the second lower lateral extending portion (i.e., when the spring is not compressed).

Embodiment 20. The modular cargo system according to embodiment 18, wherein the second width is equal to a greatest distance (measured in a lateral (or radial) direction (i.e., the direction in which the spring extends and compresses) from the outer lateral surface of the first lower lateral extending portion to the outer lateral surface of the second lower lateral extending portion (i.e., when the spring is not compressed).

Embodiment 21. The modular cargo system according to embodiment 18, wherein the second width is less than a greatest distance (measured in a lateral (or radial) direction (i.e., the direction in which the spring extends and compresses) from the outer lateral surface of the first lower lateral extending portion to the outer lateral surface of the second lower lateral extending portion (i.e., when the spring is not compressed).

Embodiment 22. The modular cargo system according to any of embodiments 1-21, wherein a width of the opening is the same (or about the same) for each rail of the plurality of rails.

Embodiment 23. The modular cargo system according to any of embodiments 1-22, wherein a width between the two slots opposite to each other is the same (or about the same) for each slot position of the plurality of slot positions within each rail of the plurality of rails.

Embodiment 24. The modular cargo system according to any of embodiments 1-23, wherein a width between the two slots opposite to each other is the same (or about the same) for all slot positions of the plurality of slot positions across all rails of the plurality of rails.

Embodiment 25. The modular cargo system according to any of embodiments 1-25, wherein each CL module of the plurality of CL modules comprises a main body (on which the handle (if present) is disposed).

Embodiment 26. The modular cargo system according to embodiment 25, wherein the main body has an upper surface that is circular or generally circular in shape.

Embodiment 27. The modular cargo system according to any of embodiments 25-26, wherein the main body comprises a lower surface (such that the spring (if present) is enclosed by the lower surface of the main body).

Embodiment 28. The modular cargo system according to any of embodiments 25-27, wherein the main body comprises a first indented space and a second indented space where the first and second upper flanges, respectively (if present), are disposed, such that the first and second upper flanges (if present) can be squeezed towards each other into the first and second indented spaces, respectively.

Embodiment 29. The modular cargo system according to any of embodiments 25-28, wherein a portion of the first upper flange connecting to the first lower inner wall is contained within a lateral wall of the main body, and

wherein a portion of the second upper flange connecting to the second lower inner wall is contained within the lateral wall of the main body.

Embodiment 30. The modular cargo system according to any of embodiments 25-29, wherein the first lower inner wall and the second lower inner wall are contained within a lateral wall of the main body.

Embodiment 31. The modular cargo system according to any of embodiments 25-30, wherein the first lower lateral extending portion extends out from the first lower wall through a first hole in a lateral wall of the main body, and

wherein the second lower lateral extending portion extends out from the second lower wall through a second hole in the lateral wall of the main body

Embodiment 32. The modular cargo system according to any of embodiments 13-31, wherein the first upper flange, the first lower inner wall, and the first lower lateral extending portion are monolithically formed with each other.

Embodiment 33. The modular cargo system according to any of embodiments 13-32, wherein the second upper flange, the second lower inner wall, and the second lower lateral extending portion are monolithically formed with each other.

Embodiment 34. The modular cargo system according to any of embodiments 1-33, wherein each CL module of the plurality of CL modules is configured to be locked into any slot position of the plurality of slot positions within a rail of the plurality of rails and also to be unlocked (e.g., by squeezing the first and second upper flanges towards each other) and slid along a length of the rail of the plurality of rails.

Embodiment 35. The modular cargo system according to any of embodiments 1-34, wherein the passenger vehicle is an electric vehicle.

Embodiment 36. A passenger vehicle comprising the modular cargo system according to any of embodiments 1-34.

Embodiment 37. The passenger vehicle according to embodiment 36, wherein the passenger vehicle is an electric vehicle.

Embodiment 38. A method of storing cargo in a passenger vehicle, the method comprising:

providing the modular cargo system according to any of embodiments 1-34;

fastening the CL modules of the plurality of CL modules in desired slot positions of the plurality of slot positions in the rails of the plurality of rails;

(attaching the at least one stretchable band to desired CL modules of the plurality of CL modules); and

storing the cargo in the passenger vehicle using the modular cargo system.

Embodiment 39. The method according to claim 38, wherein the passenger vehicle is an electric vehicle.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A modular cargo system for a passenger vehicle, the modular cargo system comprising:
a plurality of rails, each rail of the plurality of rails comprising a plurality of slot positions, wherein each slot position comprises two slots opposite to each other across an opening of the rail; and
a plurality of click and lock modules (CL modules), each CL module being configured to be removably inserted into and disposed in a slot position of the plurality of slot positions in a rail of the plurality of rails.

2. The modular cargo system according to claim 1, wherein each CL module of the plurality of CL modules comprises:
a first upper flange and a second upper flange opposite from each other and configured to be squeezed towards each other by a user of the system;
a first lower inner wall connected to the first upper flange;
a second lower inner wall opposite from the first lower inner wall and connected to the second upper flange;
a first lower lateral extending portion connected to the first lower inner wall and extending laterally away from a lower portion of the CL module; and
a second lower lateral extending portion extending laterally away from the lower portion of the CL module, the second lower lateral extending portion being opposite from the first lower lateral extending portion and being connected to the second lower inner wall,
wherein the first lower lateral extending portion and the second lower lateral extending portion are configured such that, when the first upper flange and the second upper flange are squeezed towards each other, the first lower lateral extending portion and the second lower lateral extending portion correspondingly move towards each other.

3. The modular cargo system according to claim 2, wherein each CL module of the plurality of CL modules comprises a spring disposed between the first lower inner wall and the second lower inner wall,
wherein each CL module is configured such that when the first upper flange and the second upper flange are squeezed towards each other, the first inner wall and the second inner wall correspondingly move towards each other and cause the spring to compress, and
wherein each CL module is configured such that when the spring is compressed and no external pressure is applied to the first upper flange and the second upper flange, the spring extends and causes the first inner wall and the second inner wall to move away from each other, thereby causing the first upper flange and the second upper flange to correspondingly move away from each other.

4. The modular cargo system according to claim 3, wherein, within each CL module of the plurality of CL modules, a greatest distance, measured in a lateral direction of the CL module, from an outer lateral surface of the first lower lateral extending portion to an outer lateral surface of the second lower lateral extending portion when the spring is fully extended is greater than a first width of the opening of each rail of the plurality of rails.

5. The modular cargo system according to claim 4, wherein, within each CL module of the plurality of CL modules, a second distance, measured in the lateral direction, from the outer lateral surface of the first lower lateral extending portion to an outer lateral surface of the second lower lateral extending portion when the spring is fully compressed is less than the first width.

6. The modular cargo system according to claim 5, wherein, within each slot position of the plurality of slot positions within each rail of the plurality of rails, a second width between the two slots opposite to each other is greater than both the second distance and the first width.

7. The modular cargo system according to claim 2, wherein, within each CL module of the plurality of CL modules, the first lower lateral extending portion extends laterally away from the lower portion of the CL module in a first direction parallel to a central vertical axis of the CL module, and the second lower lateral extending portion extends laterally away from the lower portion of the CL module in a second direction opposite from the first direction.

8. The modular cargo system according to claim 2, wherein each CL module of the plurality of CL modules comprises a handle at an upper portion thereof,
wherein the handle is configured to be rotated while the respective CL module is disposed in the slot position.

9. The modular cargo system according to claim 8, wherein each CL module of the plurality of CL modules comprises a main body on which the handle is disposed.

10. The modular cargo system according to claim 9, wherein, within each CL module of the plurality of CL modules, the main body comprises a first indented space and a second indented space at positions corresponding to where the first upper flange and the second upper flange, respectively, are disposed, such that the first upper flange and the second upper flange are squeezed towards each other into the first indented space and the second indented space, respectively.

11. The modular cargo system according to claim 9, wherein, within each CL module of the plurality of CL modules:
a portion of the first upper flange connecting to the first lower inner wall is contained within a lateral wall of the main body;
a portion of the second upper flange connecting to the second lower inner wall is contained within the lateral wall of the main body;
the first lower inner wall and the second lower inner wall are contained within the lateral wall of the main body;
the first lower lateral extending portion extends out from the first lower wall through a first hole in the lateral wall of the main body; and
the second lower lateral extending portion extends out from the second lower wall through a second hole in the lateral wall of the main body.

12. The modular cargo system according to claim 2, wherein, within each CL module of the plurality of CL modules:
the first upper flange, the first lower inner wall, and the first lower lateral extending portion are monolithically formed with each other; and
the second upper flange, the second lower inner wall, and the second lower lateral extending portion are monolithically formed with each other.

13. The modular cargo system according to claim 1, further comprising at least one cargo load mat, each comprising holes.

14. The modular cargo system according to claim 13, wherein the rails of the plurality of rails are respectively disposed within the holes of the at least one load cargo mat.

15. The modular cargo system according to claim 13, wherein the rails of the plurality of rails are disposed below the at least one cargo load mat and are respectively exposed through the holes of the at least one cargo load mat.

16. The modular cargo system according to claim 13, wherein the at least one cargo load mat comprises at least one of:
a first cargo load mat disposed on a floor of a cargo area of the passenger vehicle;
a second cargo load mat disposed on a back of a rear seat of the passenger vehicle;
a third cargo load mat disposed on a first side wall of the cargo area of the passenger vehicle; and
a fourth cargo load mat disposed on a second side wall of the cargo area of the passenger vehicle.

17. The modular cargo system according to claim 1, further comprising at least one stretchable band configured to be removably fastened to CL modules of the plurality of CL modules.

18. A passenger vehicle comprising the modular cargo system according to claim 1, wherein the passenger vehicle is an electric vehicle.

19. A modular cargo system for a passenger vehicle, the modular cargo system comprising:
a plurality of rails, each rail of the plurality of rails comprising a plurality of slot positions, wherein each slot position comprises two slots opposite to each other across an opening of the rail;
a plurality of click and lock modules (CL modules), each CL module being configured to be removably inserted into and disposed in a slot position of the plurality of slot positions in a rail of the plurality of rails;
at least one cargo load mat, each comprising holes; and
at least one stretchable band configured to be removably fastened to CL modules of the plurality of CL modules,
wherein each CL module of the plurality of CL modules comprises:
a first upper flange and a second upper flange opposite from each other and configured to be squeezed towards each other by a user of the system;
a first lower inner wall connected to the first upper flange;
a second lower inner wall opposite from the first lower inner wall and connected to the second upper flange;
a first lower lateral extending portion connected to the first lower inner wall and extending laterally away from a lower portion of the CL module;
a second lower lateral extending portion extending laterally away from the lower portion of the CL module, the second lower lateral extending portion being opposite from the first lower lateral extending portion and being connected to the second lower inner wall;
a handle at an upper portion of the CL module;
a main body on which the handle is disposed; and
a spring disposed between the first lower inner wall and the second lower inner wall,
wherein each CL module is configured such that when the first upper flange and the second upper flange are squeezed towards each other, the first inner wall and the second inner wall correspondingly move towards each other and cause the spring to compress,
wherein each CL module is configured such that when the spring is compressed and no external pressure is applied to the first upper flange and the second upper flange, the spring extends and causes the first inner wall and the second inner wall to move away from each other, thereby causing the first upper flange and the second upper flange to correspondingly move away from each other,
wherein, within each CL module of the plurality of CL modules:
the first lower lateral extending portion and the second lower lateral extending portion are configured such that, when the first upper flange and the second upper flange are squeezed towards each other, the first lower lateral extending portion and the second lower lateral extending portion correspondingly move towards each other;
a greatest distance, measured in a lateral direction of the CL module, from an outer lateral surface of the first lower lateral extending portion to an outer lateral surface of the second lower lateral extending portion when the spring is fully extended is greater than a first width of the opening of each rail of the plurality of rails;
a second distance, measured in the lateral direction, from the outer lateral surface of the first lower lateral extending portion to an outer lateral surface of the second lower lateral extending portion when the spring is fully compressed is less than the first width;
the first lower lateral extending portion extends laterally away from the lower portion of the CL module in a first direction parallel to a central vertical axis of the CL module, and the second lower lateral extending portion extends laterally away from the lower portion of the CL module in a second direction opposite from the first direction;
the handle is configured to be rotated while the respective CL module is disposed in the slot position;
the main body comprises a first indented space and a second indented space at positions corresponding to where the first upper flange and the second upper flange, respectively, are disposed, such that the first upper flange and the second upper flange are squeezed towards each other into the first indented space and the second indented space, respectively;
a portion of the first upper flange connecting to the first lower inner wall is contained within a lateral wall of the main body;
a portion of the second upper flange connecting to the second lower inner wall is contained within the lateral wall of the main body;
the first lower inner wall and the second lower inner wall are contained within the lateral wall of the main body;
the first lower lateral extending portion extends out from the first lower wall through a first hole in the lateral wall of the main body;
the second lower lateral extending portion extends out from the second lower wall through a second hole in the lateral wall of the main body;
the first upper flange, the first lower inner wall, and the first lower lateral extending portion are monolithically formed with each other; and
the second upper flange, the second lower inner wall, and the second lower lateral extending portion are monolithically formed with each other,
wherein, within each slot position of the plurality of slot positions within each rail of the plurality of rails, a second width between the two slots opposite to each other is greater than both the second distance and the first width,
wherein the rails of the plurality of rails are either: respectively disposed within the holes of the at least one load cargo mat; or disposed below the at least one cargo load mat and are respectively exposed through the holes of the at least one cargo load mat, and
wherein the at least one cargo load mat comprises at least one of:
a first cargo load mat disposed on a floor of a cargo area of the passenger vehicle;
a second cargo load mat disposed on a back of a rear seat of the passenger vehicle;
a third cargo load mat disposed on a first side wall of the cargo area of the passenger vehicle; and
a fourth cargo load mat disposed on a second side wall of the cargo area of the passenger vehicle.

20. A passenger vehicle comprising the modular cargo system according to claim 19, wherein the passenger vehicle is an electric vehicle.
